(19) United States
(12) Patent Application Publication
(10) Pub. No.: US 2005/0111729 A1
(43) Pub. Date: May 26, 2005

(54) Kit comprising ranges of cosmetics and a system for analyzing skin lightness level

(75) Inventor: Laurence Caisey, Thiais (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 10/962,684

(22) Filed: Oct. 13, 2004

(30) Foreign Application Priority Data
Oct. 16, 2003 (FR) 03 12104

(51) Int. Cl. G06K 9/00; G06F 17/60

(52) U.S. Cl. 382/162; 705/1

(57) ABSTRACT

The present invention provides a kit comprising: a plurality of ranges of cosmetic products, each range containing a set of products associated with a common level of skin lightness, the level of lightness being identified by an identifier; and an analysis system for analyzing at least one image of the skin, and configured to deliver an identifier representative of the lightness level of the analyzed skin, the identifier being one of the identifiers of said ranges of products.

### BACKGROUND OF THE INVENTION

It can be difficult nowadays for a consumer to choose a cosmetic, for example a makeup, that is adapted to the complexion of the consumer's skin, because of the great variety of products on offer.

### OBJECTS AND SUMMARY OF THE INVENTION

The invention seeks to make it easier to choose a cosmetic that matches a consumer's complexion.

The invention satisfies this need by means of a kit comprising:
a plurality of ranges of cosmetic products, each range containing a set of products associated with a common level of skin lightness, the level of lightness being identified by an identifier; and
an analysis system for analyzing at least one image of the skin, and arranged to deliver an identifier representative of the lightness level of the analyzed skin, the identifier being one of the identifiers of said ranges of products.

A definition of “cosmetic product” is given in EEC Council Directive 93/35 of Jun. 14, 1993, amending for the sixth time EEC Directive 76/768.

Cosmetic products comprise products for making up the skin, the nails, and the mucous membranes and care products serving, for example, to reduce signs of aging and to protect or moisturize the skin.

The term “deliver” is used to mean issuing a visible or audible message, e.g. displaying information on a light-emitting diode (LED) display or on a screen of the cathode ray tube (CRT), liquid crystal, or other type, printing information, sounding over a loudspeaker on the premises where analysis takes place, or sending information remotely, for example by telephone or computer messaging or by physical mail.

The term “identifier” is used to mean any sign that can be used for identifying the level of lightness, for example one or more written characters, for example alphanumeric characters, one or more pictograms, one or more colors, one or more areas in relief, or indeed in the form of special packaging. The identifier need not necessarily appear on the packaging of the product. It could appear, for example, on a medium of the paper or software type, for example on a screen page, in association with the commercial references for the product that is associated with the corresponding level of lightness.

By means of the invention, choosing makeup that matches complexion is made easier since consumers aware of their own levels of lightness, or a person advising consumers, can select the product from a small number of products making up the corresponding range, thereby achieving a significant saving in time and providing additional reliability, with the risk of choosing a makeup or care product that is not suitable being reduced or even eliminated.

The level of lightness is not necessarily expressed in connection with a reference color space, for example the CIE 1976 (L*a*b*) color space. Optionally the level of lightness may be related to a range of values of psychometric luminosity in the CIE 1976 (L*a*b*) color space.

The analysis system may be implemented in a variety of forms, for example as a function of the location where analysis takes place, for example at a point of sale, in a beauty parlor, or at the consumer's home.

The analysis system advantageously comprises a camera, preferably a color camera, enabling at least one image of the skin to be acquired with optical magnification.

By way of example, the magnification factor may lie in the range 3 to 15.

The color camera may be arranged to deliver red, green, and blue signals.

The camera advantageously includes an integrated light source, for example a source of white light, and it may be arranged, for example, in such a manner as to be suitable for being pressed against the skin while acquiring an image, thereby facilitating focusing.

The camera may be an inexpensive camera.

The camera may be connected to the remainder of the analysis system over a wire or a wireless link. Where appropriate, the image may be transmitted to the remainder of the analysis system by a telephone or computer network.

The camera preferably does not include automatic white level balancing, or if it does, it is deactivated.

In an implementation of the invention, the analysis system is configured for converting the image delivered by the camera into a monochrome image, for example a green and black image, e.g. using the green signal, and for determining the mean luminosity (i.e. relative quantity of light) of at least a portion of the monochrome image. It would also be possible to use a monochrome camera.

The analysis system may comprise, for example, a microcomputer fitted with a graphics acquisition card and programmed in such a manner as to calculate the mean luminosity from at least one image transmitted by the camera. The calculation may be performed in real time.

The analysis system may be arranged to associate a level of lightness with the mean luminosity value as calculated in this way, e.g. by using a correspondence table in which each level of lightness is associated with a range of mean luminosity values.

The mean luminosity may be calculated over all or at least part of the image, and for example it may be calculated after acquiring a plurality of images, with the mean luminosity being calculated for each of them and with the mean then being taken of the mean values as obtained in this way.

The number of lightness levels is greater than 2, for example lies in the range 3 to 25, and advantageously in the range 6 to 12, e.g. being equal to 9.

The analysis system may also be arranged, where appropriate, to deliver information relating to the tone of the skin color, for example an indication representing a yellowish tone or a reddish tone of the skin.

This indication may be presented, for example, beside the identifier for the lightness level, on each product in said ranges, or on a medium containing the references of the products, for example their commercial references.

In another aspect of the invention, the kit includes at least one medium for facilitating choosing a product, given the level of skin lightness.

This medium may, for example, be in “paper” form or in “software” form.

The medium may be arranged in such a manner as to enable the consumer to view a plurality of pages containing information associated with the products of said ranges.

When using paper, the medium may, for example, be in the form of a brochure comprising bound sheets with index tabs having the various identifiers printed thereon, the tabs giving quick access to the products in the range corresponding to the identifier concerned.

The medium may also be arranged to show the effects of makeup obtained with given products in a range.

For example, the medium may comprise panels corresponding to respective portions of the face and enabling the made-up appearance of a portion of the face to be modified, while leaving unchanged the appearance of the other portion(s) of the face corresponding to the other panel(s).

By way of example, the medium may comprise panels corresponding to half-faces, for example top panels corresponding to making up the eyes and bottom panels corresponding to making up the lips and the cheeks.

For at least one level of lightness, the medium may comprise at least two successive panels corresponding to the same portion of the face, each of the panels having an image of the face on its front, and information relating to the makeup products on its back. The panels may be arranged in such a manner that the products referenced on the back of one panel correspond to the result of the makeup shown on the front of the immediately following panel.

Such a medium enables the consumer to see the results of various combinations of making up the top and bottom of the face, while also being able to identify quickly the products that enable the makeup to be obtained.

A similar result can be obtained when the medium is in the form of software programmed to enable a simulation of makeup to be displayed simultaneously on the same screen page as the product(s) used for the simulation.

Software can also be adapted to enable the simulation of the makeup to be performed on an image of the consumer, after acquiring such an image by means of a camera or a scanner, or by receiving a computer file.

The information relating to products that appears on the medium, may include for example a sample of the color of the product, a reference number and/or the trademark of the product, the nature of the surface that is to receive the product, for example the nature of the skin when the product is for application to the skin. The medium may for example specify for a given product at least the type of skin for which the product is intended, i.e. dry skin, normal, normal to mixed skin, all types of skin, mixed skin, and/or where appropriate, indicate whether the product produces an anti-aging effect.

The medium may also include information associated with the form of the product, and for example indicating whether it is in the form of a liquid or a solid, and for example whether it is in powder or in compact form.

The medium may also include information associated with the color tone that the product serves to provide, for example makeup of tanned type, matching tone, or of lightening type.

Each range of products may include products for application to the skin, such as foundations, eyeshadows, eyeliners, blushes, products for application to the mucous membranes such as lipsticks, lip pencils, products for application to the eyelashes or the eyebrows such as mascaras, eyebrow pencils, kohl pencils, and products for application to the nails such as nail varnishes.

In another of its aspects, the invention also provides a system for analyzing skin lightness, the system comprising:
a camera enabling at least one image of the skin to be acquired; and
a processor for processing at least one image acquired by the camera, and configured to deliver an identifier associated with a measured level of lightness, the identifier also appearing:
   on the products in a plurality of ranges of products associated with the respective different levels of lightness that can be delivered by the processor; or
   on a medium comprising the references of products in a plurality of ranges of products associated respectively with the different levels of lightness can be delivered by the processor.

In another of its aspects, the invention provides a method of cosmetically treating, for example making up the skin, the nails, or the mucous membranes, the method comprising:
associating an identifier with a consumer, the identifier enabling the lightness level of the consumer's skin to be identified;
as a function of said identifier, selecting at least one cosmetic product from a set of ranges of products identified by the lightness level identifiers; and
making up the consumer with the selected product(s).

The invention also provides a method for providing beauty advice, the method comprising:
associating an identifier with a consumer, the identifier enabling the lightness level of the consumer's skin to be identified;
as a function of said identifier, advising at least one cosmetic product from a set of ranges of products identified by the lightness level identifiers.

The invention also provides a method of manufacturing a set of ranges of cosmetic products, for example products for making up the skin, the mucous membranes, and the nails, comprising applying to each product of the range an identifier corresponding to the level of lightness of the skin for which the product is suitable.

By way of example, the identifier may be a sign that appears on a label stuck to a receptacle containing the product or printed thereon.

The invention also provides a method of manufacturing a set of ranges of cosmetic products, for example products for making up the skin, the mucous membranes, and the nails, including allocating to each product of the range an identifier corresponding to the level of lightness of the skin for which the product is appropriate, the identifier may be allocated, for example, by placing at least one reference, e.g. a commercial reference, on the product, in a correspondence table together with an identifier of the level of lightness. The table may be a document of paper type or a computer file.

### BRIEF DESCRIPTION OF THE DRAWINGS

The invention can be better understood on reading the following detailed description of non-limiting implementations thereof, and on examining the accompanying drawings, which form an integral part of the description, and in which:

FIG. 1 is a diagrammatic and fragmentary view of an analysis system constituting an embodiment of the invention;

FIG. 2 shows a variant of the analysis system of FIG. 1;

FIG. 3 is a block diagram for illustrating an example of the analysis system in operation;

FIG. 4 shows an examples of cosmetic products including identifiers enabling lightness level to be identified;

FIG. 5 shows an example of a medium that makes it easier to select a product in the knowledge of the lightness level;

FIG. 6 shows the FIG. 5 medium after turning one of the top panels as shown by arrow P in FIG. 5;

FIG. 7 shows in greater detail the backs of two panels that can be juxtaposed; and

FIGS. 8 and 9 show two examples of pages having information marked thereon relating to foundation makeup in two ranges of products respectively adapted to different levels of lightness.

### MORE DETAILED DESCRIPTION

FIG. 1 is a diagram of an analysis system 1 made in accordance with the invention, comprising a camera 2 and processor means 3 for processing the information delivered by the camera, the processor system being shown in FIG. 1 in the form of a microcomputer having a screen 4.

The microcomputer may be of any known type, and in the example described it includes a graphics acquisition card enabling images delivered by the camera 2 to be captured for treatment purposes.

Where appropriate, the microcomputer 3 is connected via a computer network such as the Internet to a remote server in order to exchange information therewith, and for example in order to enable the remote server to record information associated with the images acquired and processed by the microcomputer.

The camera 2 is preferably a color camera including built-in lighting and an optical system for magnifying several times.

By way of example, the analysis system 1 is present at a point of sale or in a beauty parlor.

The analysis system 1 may also be present in the home of the consumer. In this case, the processing of the images acquired by the camera may be performed at the consumer's home, or remotely, after transmitting an image of at least the skin to a server.

In accordance with the invention, the analysis system 1 is arranged, after acquiring at least one image, to deliver an identifier 5 which may be in the form, for example, of an alphanumeric message that is displayed on the screen 4.

The identifier 5 may also be placed on the products in a range of cosmetic products so as to allow the consumer to identify these products as being well adapted to the corresponding level of lightness. In a variant, the identifier 5 is not placed on the products, but a means is provided that enables the products that are associated with an identifier to be determined, for example means in the form of a medium as described below.

Preferably, all of the lightness levels that are to be found in the population corresponds to a fairly small number of identifiers, for example a number lying in the range 6 to 12, and equal to 9 in the example described.

Naturally, the number of identifiers may depend on geographical region, and for example on the number of different ethnic categories to found therein.

It is thus possible to propose different numbers of identifiers to consumers in Asia, North America, and Europe, for example.

In the example described, each of the identifiers 5 is in the form of alphanumeric characters comprising one or more letters and a number, the identifiers being selected, for example, from: Ci1, Ci2, Ci3, . . . , Ci8, Ci9.

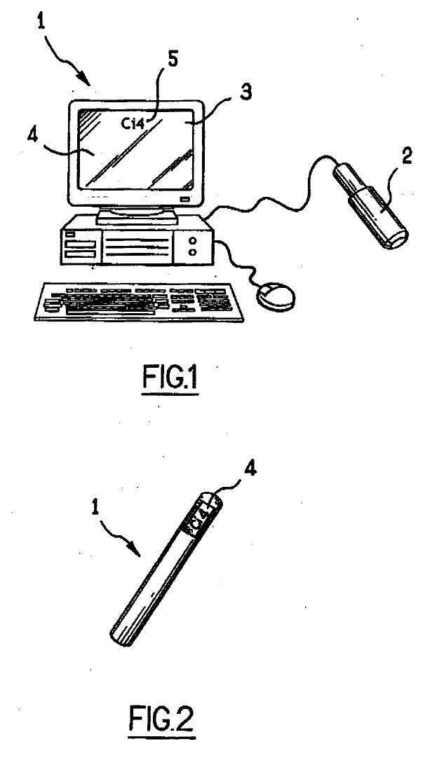

FIG. 2 shows a variant of the analysis system 1 in which it is in the form of a self-contained portable device including a display 4, a camera, and processor means that are not visible.

Where appropriate, the analysis system may also exchange information with a computer or a portable terminal over a wireless link, for example of the Wi-Fi® or the Bluetooth® type.

The analysis system may also comprise a portable terminal, for example a mobile telephone, fitted with a camera and programmed in such a manner, that once calibrated, it can process the image acquired by the camera so as to display an identifier corresponding to the level of lightness of the skin.

Where appropriate, the mobile telephone may be associated during image acquisition with an optical device including a built-in light source and a magnifying optical system.

In another variant, it is possible to use a portable terminal for acquiring an image of the skin and for sending the image over the telephone network to a remote server arranged to process the image and to deliver the identifier in return.

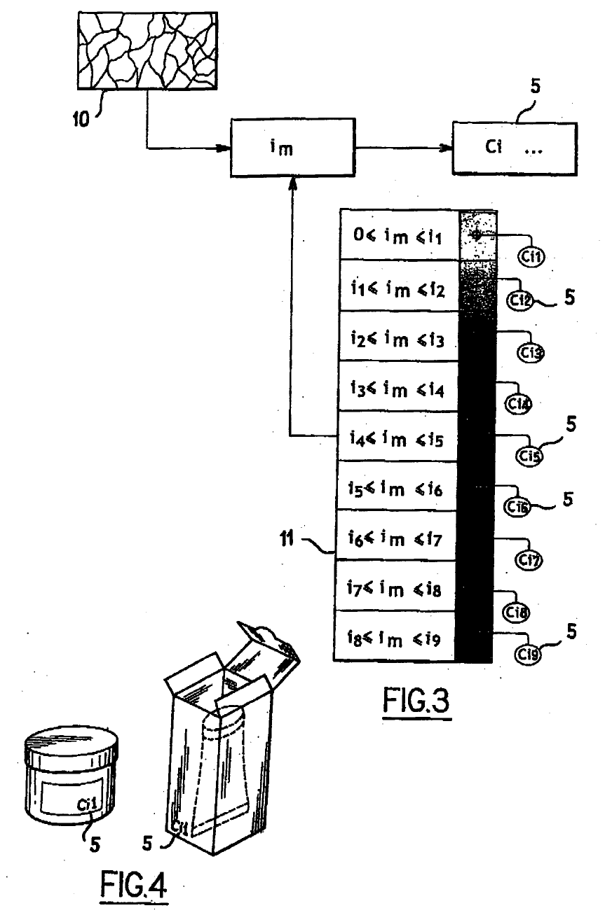

With reference to FIG. 3, there follows a description of an example of how the analysis system 1 operates.

One or more images 10 are acquired by the camera 2, and where appropriate recorded in the analysis system 1.

The color image(s) is/are transformed into monochrome images, e.g. by using only the green signal. The camera used does not have automatic white balancing, or if it does, it is deactivated.

For each monochrome image, a mean luminosity iₘ is determined, and when a plurality of images are acquired, a mean of the mean values iₘ can be calculated.

Furthermore, the analysis system 1 has in memory, or can access, a database in which there is recorded a correspondence table 11 between each identifier 5 that can be displayed and a range of mean luminosity value iₘ.

This correspondence table 11 may have been previously defined, e.g. during a stage of calibrating the analysis system 1, by presenting the camera 2 in succession to a set of samples having reference lightness levels.

As a function of the measured mean luminosity iₘ and of the correspondence table 11, the analysis system 1 delivers the corresponding identifier.

Naturally, it would not go beyond the ambit of the present invention for the lightness level to be determined otherwise, for example when more complex processing is performed, not making use of a monochrome image, but using, for example, all of the color signals in the image acquired by the camera 2.

Acquisition by the camera 2 of a plurality of images can be advantageous in that it enables acquisitions to be performed on different areas of the face or the body. The analysis system can be used, for example, to acquire images from the forehead and from the cheeks, for example.

Each image acquired by the camera 2 can be displayed on the screen 4 so as to enable the operator to verify that the image has been acquired under good conditions.

Where appropriate, a mosaic can be displayed on the screen 4 representing all of the images acquired by the camera 2 that are to be processed by the analysis system in order to determine a lightness level.

Where appropriate, once the lightness level has been determined, the corresponding information can be sent over a computer or telephone network to a remote server which forwards the information together with the name or other means enabling the person concerned to be identified, so as to make it possible subsequently to propose automatically products that are suitable for the person.

Once the identifier 5 is known, the consumer or the person advising the consumer finds choosing products adapted to this level of lightness made easier by the presence, in accordance with the invention, of ranges of products associated with the respective different possible levels of lightness.

A user having lightness level Ci1 may, for example, choose amongst products in the range associated with lightness level Ci1; each carrying the Ci1 identifier, as shown in FIG. 4.

A given identifier Ci . . . can be applied to a corresponding product in various ways, for example it can be printed on the packaging containing the product or on the receptacle itself, or it may appear on a label stuck to the packaging or the receptacle. Where appropriate, the identifier need not appear directly on the product, and a correspondence table could be used, for example.

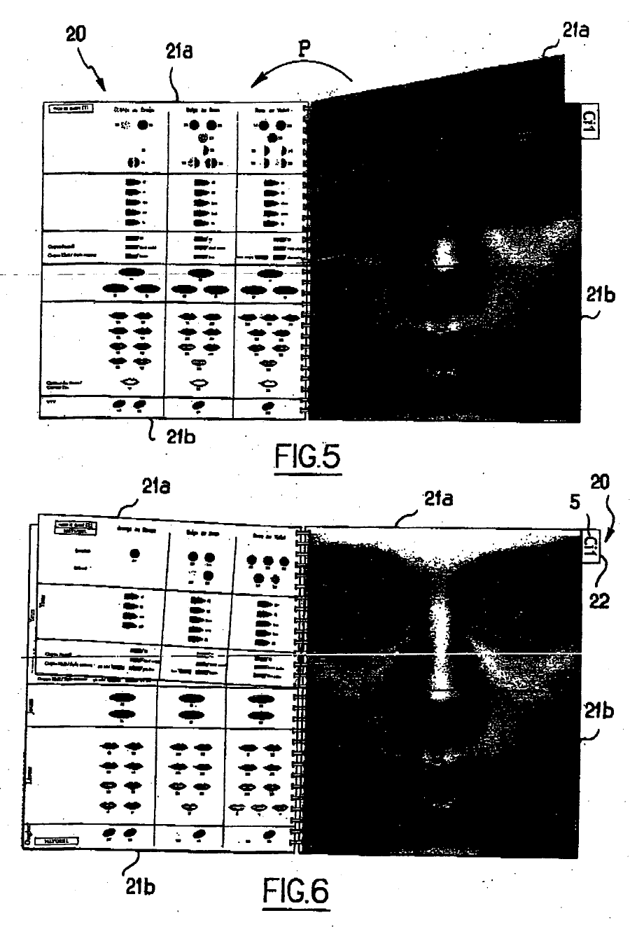

In order to assist the consumer in making a choice, a medium 20 such as that shown in FIGS. 5 and 6 can be made available to the user.

This medium 20 is in the form of a brochure comprising a bound set of sheets or panels, for example.

The brochure includes identification means enabling the user to access quickly the range corresponding to the user's level of lightness. In the example shown, these identification means comprise index tabs 22 each having the corresponding lightness level printed thereon.

Preferably, in order to enable the user to visualize the effects of the makeup, the medium 20 comprises panels that can be juxtaposed to show a complete face and associated with respective different portions of the face, for example top panels 21a and bottom panels 21b in the example shown, the eyes and the top portion of the nose being shown on the fronts of the top panels 21a, and the bottom of the nose, the cheeks, and the lips being shown on the fronts of the bottom panels 21b.

The backs of the panels 21a and 21b carry information relating to the products used in order to achieve the makeup shown on the front of the following panel.

Thus, when the brochure is open, the user can read information on the left-hand page that corresponds to the makeup shown on the right-hand page, and can modify the makeup on the top portion or on the bottom portion of the face at will by turning the corresponding panels.

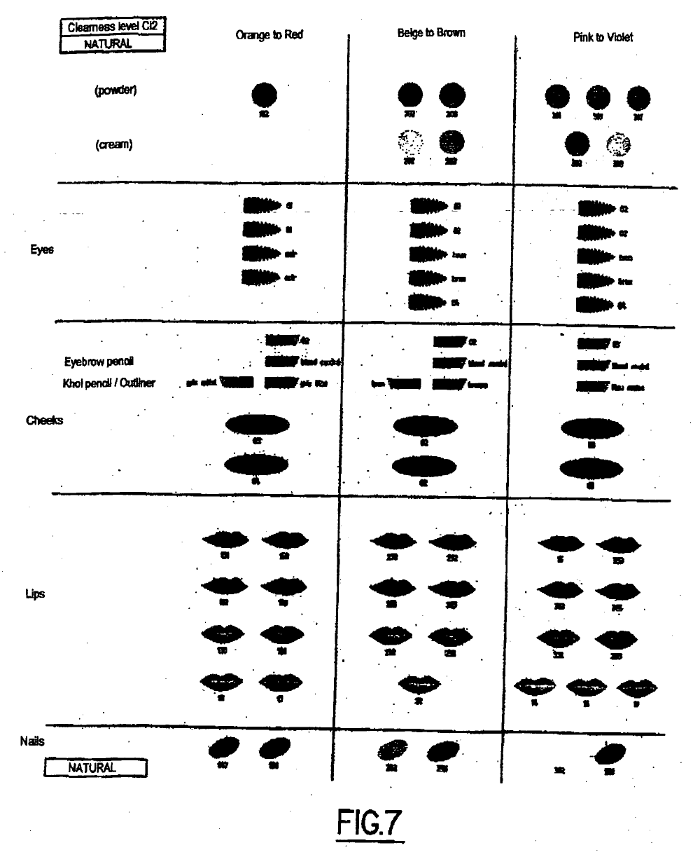

Examples of the information that appears on the backs of two panels that can be juxtaposed are shown in FIG. 7.

This information may comprise, for example, samples of the colors of the products and also a reference number or a trademark.

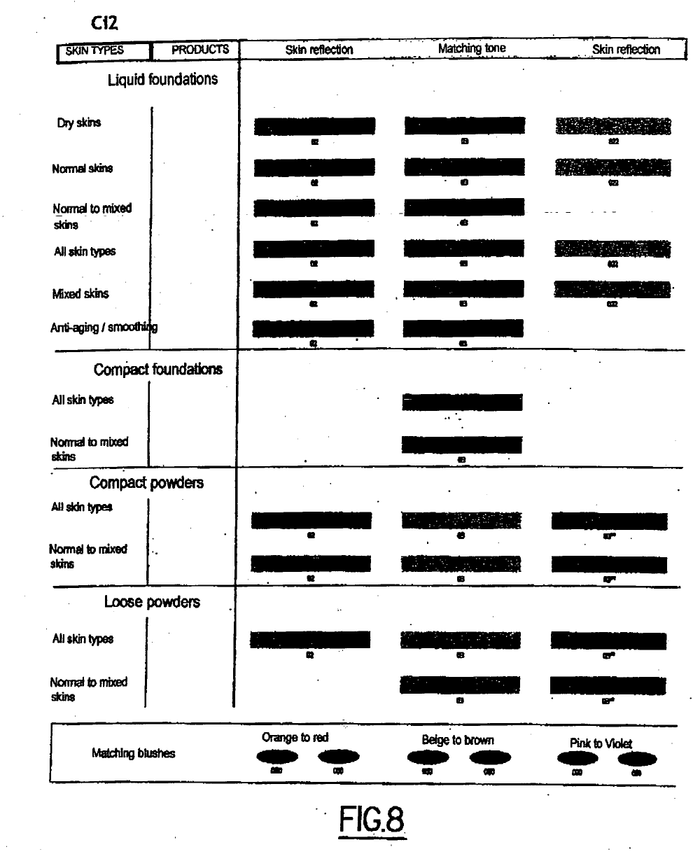

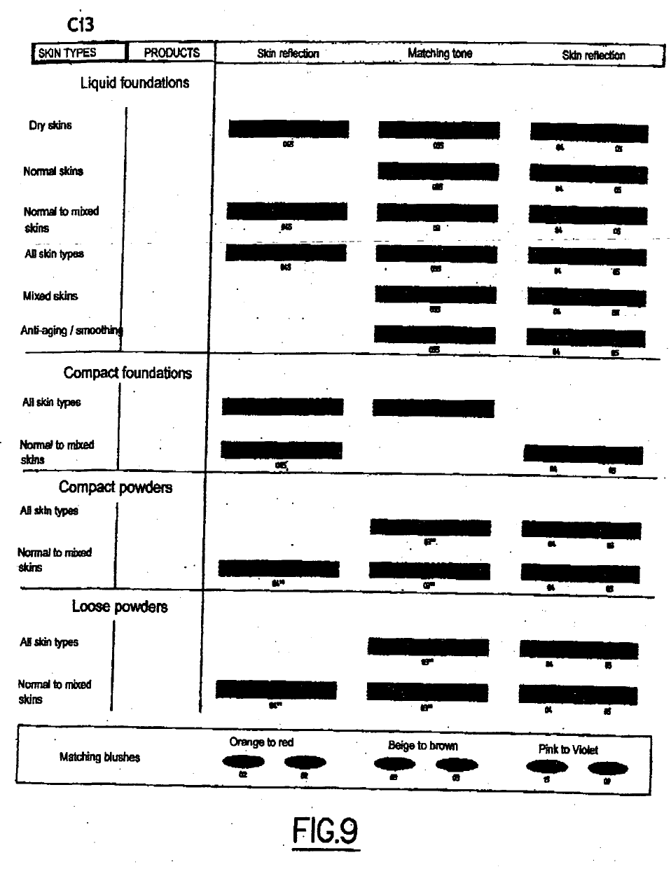

The medium 20 may also include pages of the kind shown by way of example in FIGS. 8 and 9.

These pages may carry information relating to families of products, for example foundations, distinguished by their forms, e.g. fluid, compact, compact powder, or loose powder, the colors available for each type of skin, for example dry skin, normal skin, normal to mixed skin, all types of skin, or the desired effect, for example anti-aging/smoothing. The colors may be identified as a function of the effect that is to be obtained, for example tanning, matching tones, or lightening.

The medium 20 is not restricted to being of paper form, and it may also be in software form, for example it may be delivered to the consumer after analysis of the skin as recorded on a computer medium such as a CD-Rom or as delivered to the computer in the form of a file by e-mail.

Naturally, the invention is not limited to the examples described above, and skin lightness level can be measured simultaneously with performing other analyses of the skin, for example measuring its hydration, its sebum content, etc.

Throughout the description, the term “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A kit comprising:
a plurality of ranges of cosmetic products, each range containing a set of products associated with a common level of skin lightness, the level of lightness being identified by an identifier; and
an analysis system for analyzing at least one image of the skin, and configured to deliver an identifier representative of the lightness level of the analyzed skin, the identifier being one of the identifiers of said ranges of products.

2. A kit according to claim 1, wherein the analysis system comprises a camera enabling at least one image of the skin to be acquired with optical magnification.

3. A kit according to claim 2, wherein the camera is a color camera.

4. A kit according to claim 2, wherein the magnification factor of the camera lies in the range 3 to 15.

5. A kit according to claim 2, wherein the camera comprises a built-in light source.

6. A kit according to claim 5, wherein the camera comprises a source of white light.

7. A kit according to claim 1, wherein the camera does not have automatic white balance activated.

8. A kit according to claim 2, wherein the camera is configured to be capable of being applied against the skin.

9. A kit according to claim 1, wherein the analysis system is configured to convert the image delivered by the camera into a monochrome image, and to determine the mean luminosity from at least a portion of the monochrome image.

10. A kit according to claim 9, wherein the monochrome image is a green and black image.

11. A kit according to claim 1, wherein the analysis system comprises a microcomputer fitted with a graphics acquisition card and programmed in such a manner as to calculate a mean luminosity from at least one image transmitted by a camera.

12. A kit according to claim 11, wherein the analysis system is configured to allocate a mean luminosity value to a lightness level.

13. A kit according to claim 12, wherein the analysis system uses a correspondence table in which each lightness level is associated with a range of mean luminosity values.

14. A kit according to claim 1, wherein the number of lightness levels is greater than 2.

15. A kit according to claim 14, wherein the number of lightness levels lies in the range 3 to 25.

16. A kit according to claim 14, wherein the number of lightness levels lies in the range 6 to 12.

17. A kit according to claim 14, wherein the number of lightness levels in equal to 9.

18. A kit according to claim 1, wherein the analysis system is configured to deliver information relating to the color tone of the skin.

19. A kit according to claim 18, wherein said information comprises an indication specifying one of a yellowing tone and a reddish tone of the skin.

20. A kit according to claim 1, comprising at least one medium for facilitating choosing a product, in the knowledge of the lightness level of the skin.

21. A kit according to claim 20, wherein the medium is configured to enable the consumer to view a plurality of pages containing-information-associated with the products of said ranges.

22. A kit according to claim 20, wherein the medium comprises a brochure comprising bound sheets with index tabs having the various identifiers printed thereon.

23. A kit according to claim 20, wherein the medium comprises panels corresponding to respective portions of the face and enabling the appearance of the makeup of a portion only of the face to be modified while leaving the makeup unchanged for the other portion(s) of the face corresponding to the other panel(s).

24. A kit according to claim 22, wherein the medium comprises panels corresponding to half-faces.

25. A kit according to claim 24, wherein the medium comprises top panels corresponding to making up the eyes, and bottom panels corresponding to making up the lips and cheeks.

26. A kit according to claim 22, wherein, for at least one lightness level, the medium comprises at least two successive panels corresponding to the same portion of the face, each of these panels having on its front an image of the face, and on its back information relating to the makeup product for the eyes or the cheeks, the panels being configured in such a manner that the products referenced on the back of one panel correspond to the makeup shown on the front of the immediately following panel.

27. A kit according to claim 20, wherein the medium comprises software that is programmed to enable a simulation of makeup to be displayed simultaneously on the same screen page as the product(s) used for the simulation.

28. A kit according to claim 1, wherein each range of products comprises at least one of: products for application to the skin, such as foundations, eyeshadows, eyeliners, blushes, products for application to the mucous membranes such as lipsticks, lip pencils, products for application to the eyelashes or the eyebrows, such as mascaras, eyebrow pencils, kohl pencils, and products for application to the nails, such as nail varnishes.

29. A system for analyzing skin lightness, the system comprising:
a camera enabling at least one image of the skin to be acquired; and
processor for processing at least one image acquired by the camera, and configured to deliver an identifier associated with a measured level of lightness, the identifier also appearing:
on the products in a plurality of ranges of products associated with the respective different levels of lightness that can be delivered by the processor; or
on a medium comprising the references of products in a plurality of ranges of products associated respectively with the different levels of lightness can be delivered by the processor.

30. A method of cosmetic treatment, the method comprising:
associating an identifier with a consumer, the identifier enabling the lightness level of the consumer's skin to be identified;
as a function of said identifier, selecting at least one cosmetic product from a set of ranges of products identified by the lightness level identifiers; and
making up the consumer with the selected at least one cosmetic product.

31. A method according to claim 30, for making up the skin, the nails or the mucous membranes.

32. A method of manufacturing a set of ranges of cosmetic products, the method comprising placing on each product of the range an identifier corresponding to a skin lightness level for which the product is suitable.

33. A method according to claim 32, wherein said products are products for making up at least one of the skin, the mucous membranes and the nails.

34. A method according to claim 32, wherein the identifier is a sign that appears in a label stick to a receptacle containing the product or printed thereon.

35. A method of manufacturing a set of ranges of cosmetic products, the method comprising allocating an identifier to each product in the range, the identifier corresponding to a skin lightness level for which the product is suitable, identifier allocation being performed by entering at least one reference in a correspondence table together with a lightness level identifier.

36. A method according to claim 35, wherein said products are products for making up at least one of the skin, the mucous membranes and the nails.

37. A method according to claim 35, wherein the table comprises at least one of a paper type document and a computer file.

38. A method for providing a beauty advice, comprising:
associating an identifier with a consumer, the identifier enabling the lightness level of the consumer's skin to be identified;
as a function of said identifier, advising at least one cosmetic product from a set of ranges of products identified by the lightness level identifiers.
